(19) United States
(12) Patent Application Publication
(10) Pub. No.: US 2022/0317284 A1
(43) Pub. Date: Oct. 6, 2022

(54) SURVEILLANCE SYSTEM, AND SURVEILLANCE METHOD

(71) Applicant: Panasonic Corporation, Osaka (JP)

(72) Inventors: Makoto YASUGI, Tokyo (JP); Yoji YOKOYAMA, KANAGAWA (JP)

(73) Assignee: Panasonic Corporation, Osaka (JP)

(21) Appl. No.: 17/619,528

(22) PCT Filed: Jun. 4, 2020
(86) PCT No.: PCT/JP2020/022192

§ 371 Date: Dec. 15, 2021

(30) Foreign Application Priority Data
Jun. 21, 2019 (JP) 2019-115728

(51) Int. Cl. G01S 13/91; G08G 1/056; G01S 7/04

(52) U.S. Cl. CPC G01S 13/91; G08G 1/056; G01S 7/04

(57) ABSTRACT

This surveillance system is provided with: a radar device which generates information indicating the reflection positions of radiated radio waves; and a surveillance device which, on the basis of the information indicating the reflection positions, detects a moving body in a radiation range of the radio waves, and determines whether an occlusion region, which is a region in the radiation range that cannot be reached by the radio waves, has arisen, and which generates surveillance information including information indicating the result of the moving body detection, and information indicating whether an occlusion region has arisen.

### TECHNICAL FIELD

The present disclosure relates to a monitoring system and a monitoring method.

### BACKGROUND ART

Conventionally, a monitoring system for monitoring traffic on roads using a radar apparatus is known. Patent Literature (hereinafter, referred to as “PTL”) 1 discloses a technique for two-dimensionally locating the positions of objects such as vehicles, obstacles, and fixed structures by a radar apparatus radiating radar waves and receiving reflected waves from an object existing at a radiation destination to detect information on the position and the moving speed of the object.

PTL 1 also discloses an estimating technique in which so-called occlusion meaning that an obstacle is temporarily hidden by another object is estimated when the obstacle has been detected in the past but is not detected at the present time in obstacle detection processing.

### CITATION LIST

### Patent Literature

PTL 1
Japanese Patent Application Laid-Open No. 2013-257288

### SUMMARY OF INVENTION

### Technical Problem

When occlusion occurs, the reliability of a monitoring result of the monitoring system decreases because the object in an occlusion region cannot be detected. However, since objects do not totally reflect the radiated radar waves (i.e., the radar apparatus cannot fully receive the reflected waves), judgement of whether or not occlusion has occurred is only estimated judgement. Therefore, even when it is judged that occlusion has occurred, a decrease in the reliability of monitoring cannot necessarily be concluded.

One non-limiting and exemplary embodiment of the present disclosure facilitates providing a technique that allows a user, another apparatus, and/or the like to recognize the possibility of a decrease in reliability of a monitoring result when it is judged that occlusion has occurred.

### Solution to Problem

A monitoring system according to an aspect of the present disclosure includes: a radar apparatus that generates information indicating a reflection position of a radio wave radiated; and a monitoring apparatus that performs, based on the information indicating the reflection position, detection of one or more mobile entities in a radiation range of the radio wave and judgement of whether or not an occlusion region being unreachable by the radio wave has occurred in the radiation range, and generates monitoring information including information indicating a result of the detection of the one or more mobile entities and information indicating whether or not the occlusion region has occurred.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

### Advantageous Effects of Invention

According to one non-limiting and exemplary embodiment of the present disclosure, it is possible to allow a user, another apparatus, and/or the like to recognize the possibility of a decrease in reliability of a monitoring result when it is judged that occlusion has occurred.

Additional benefits and advantages of one aspect of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of scanning of an intersection by a radar apparatus according to Embodiment 1;

FIG. 2 illustrates a configuration example of a monitoring apparatus according to Embodiment 1;

FIG. 3 is a graph showing an example in which scanning information according to Embodiment 1 is superimposed on background scanning information;

FIG. 4A illustrates an example of an occlusion region displayed in a first mode according to Embodiment 1;

FIG. 4B illustrates an example of the occlusion region displayed in a second mode according to Embodiment 1;

FIG. 4C illustrates an example of the occlusion region displayed in a third mode according to Embodiment 1;

FIG. 5 is a flowchart illustrating an example of processing of the monitoring apparatus according to Embodiment 1;

FIG. 6 is a flowchart illustrating an example of processing of a monitoring information generator according to Embodiment 1;

FIG. 7 illustrates a configuration example of a traffic flow measurement system according to Embodiment 2;

FIG. 8 illustrates an example of arrangement of count lines according to Embodiment 2;

FIG. 9 is a graph showing an example of the number of vehicles having passed the count line according to Embodiment 2;

FIG. 10 illustrates a configuration example of an opposite travel detection system according to Embodiment 3;

FIG. 11 illustrates an example of arrangement of opposite travel judgement lines according to Embodiment 3;

FIG. 12 illustrates an example of an opposite travel monitoring image according to Embodiment 3;

FIG. 13 illustrates a configuration example of a pedestrian detection system according to Embodiment 4;

FIG. 14 illustrates an example of display of attention calling information according to Embodiment 4;

FIG. 15 illustrates a variation of the configuration of the pedestrian detection system according to Embodiment 4;

FIG. 16 illustrates a configuration example of an intruder detection system according to Embodiment 5;

FIG. 17A illustrates an example of a radiation range of a radar apparatus according to Embodiment 5;

FIG. 17B illustrates an example in which an occlusion region has occurred in the radiation range of the radar apparatus according to Embodiment 5;

FIG. 18 illustrates an example of monitoring log information according to Embodiment 5; and

FIG. 19 illustrates an example of a hardware configuration according to an embodiment of the present disclosure.

### DESCRIPTION OF EMBODIMENTS

Embodiments of the invention will be described in detail below with appropriate reference to the accompanying drawings. However, any unnecessarily detailed description may be omitted. For example, any detailed description of well-known matters and redundant descriptions on substantially the same configurations may be omitted. This is to avoid the unnecessary redundancy of the following description and to facilitate understanding by those skilled in the art.

Note that, the accompanying drawings and the following description are provided to enable those skilled in the art to fully understand the present disclosure, but are not intended to limit the claimed subject.

### Embodiment 1

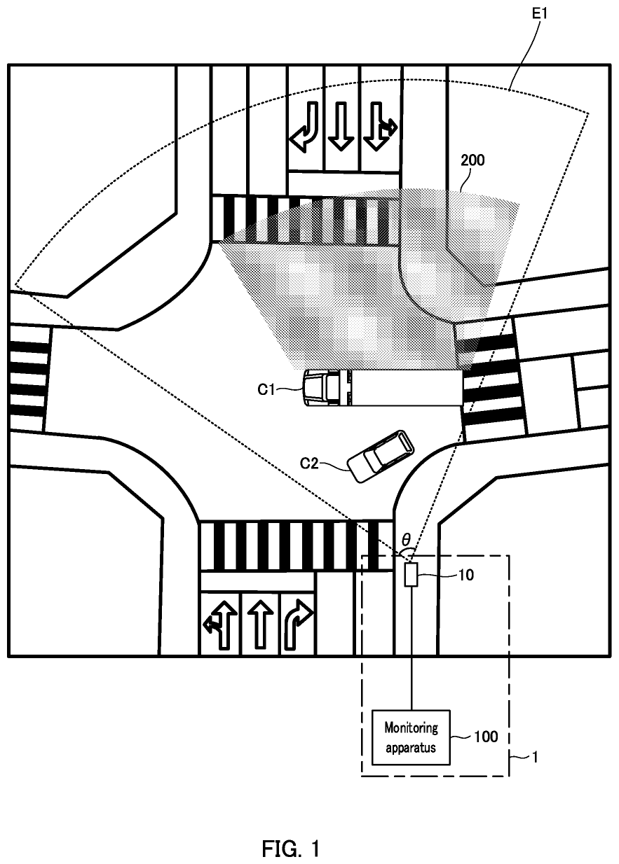

FIG. 1 illustrates an example of scanning of an intersection by a radar apparatus.

Monitoring system 1 includes radar apparatus 10 and monitoring apparatus 100. Radar apparatus 10 is connected to monitoring apparatus 100 via a predetermined communication network.

Radar apparatus 10 installed at an intersection radiates a radar wave in a millimeter-wave band to radiation range E1 while changing angle θ, and receives reflected waves from objects (vehicles, pedestrians, and fixed structures, etc.) existing at the intersection. Radar apparatus 10 locates reflection positions of the radar wave based on radiation angle θ of the radar wave and the time from transmission of the radar wave to reception of the reflected waves. Radar apparatus 10 transmits information indicating the located reflection positions (hereinafter referred to as “reflection position information”) to monitoring apparatus 100.

Monitoring apparatus 100 maps a plurality of pieces of reflection position information received from radar apparatus 10 to a two-dimensional map to generate scanning information.

Here, as illustrated in FIG. 1, when tall heavy-duty truck C1 is present within radiation range E1 of radar apparatus 10, for example, the radar wave is reflected by heavy-duty truck C1. Thus, occlusion region 200 where it is impossible to detect an object occurs behind heavy-duty truck C1.

Occurrence of occlusion region 200 in radiation range E1 of radar apparatus 10 affects the reliability of a monitoring result with respect to radiation range E1. In view of the above, monitoring system 1 according to the present embodiment estimates a decrease in reliability of the monitoring result with respect to radiation range E1 based on whether or not occlusion region 200 has occurred. It is thus possible for monitoring system 1 to perform appropriate processing in consideration of the decrease in reliability of the monitoring result. Detailed descriptions will be given below.

<System Configuration>

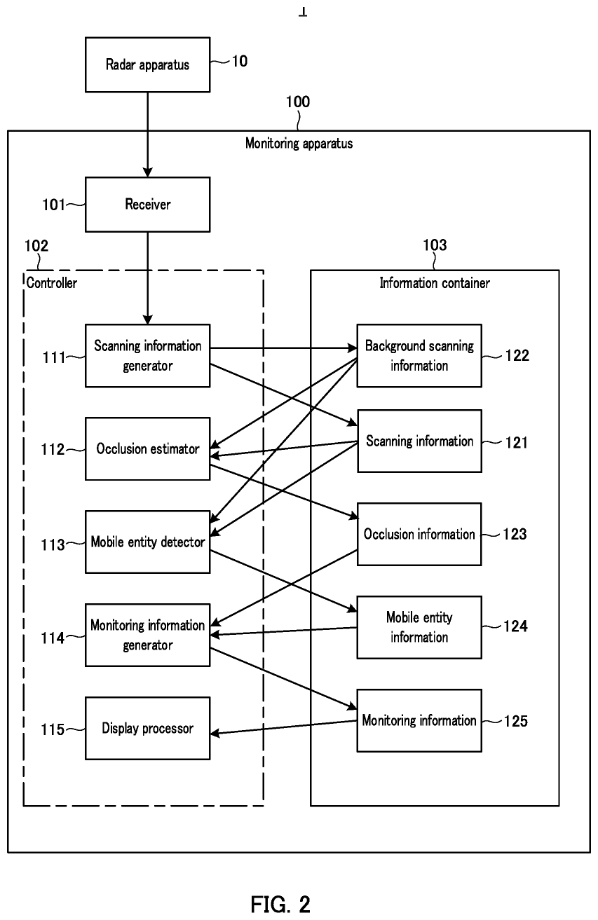

FIG. 2 illustrates an exemplary configuration of monitoring apparatus 100.

Monitoring apparatus 100 includes receiver 101, controller 102, and information container 103. Controller 102 implements functions of scanning information generator 111, occlusion estimator 112, mobile entity detector 113, monitoring information generator 114, and display processor 115.

Receiver 101 receives the reflection position information from radar apparatus 10 and transmits it to scanning information generator 111.

Scanning information generator 111 maps a plurality of pieces of reflection position information received from radar apparatus 10 to a two-dimensional map to generate scanning information 121. Scanning information 121 is stored in information container 103. Here, scanning information generator 111 stores, in information container 103 as background scanning information 122, scanning information 121 on scanning at a timing at which no mobile entity (for example, a vehicle or a pedestrian) exists in the radiation range. Note that, details of scanning information generator 111 will be described later.

Based on scanning information 121 and background scanning information 122, occlusion estimator 112 estimates whether or not occlusion region 200 has occurred within the radiation range. When it is estimated that occlusion region 200 has occurred, occlusion estimator 112 generates occlusion information 123 indicating occlusion region 200. Occlusion information 123 is stored in information container 103.

Mobile entity detector 113 detects the position of a mobile entity based on scanning information 121 and background scanning information 122. Further, mobile entity detector 113 detects a movement track of the mobile entity based on a change of scanning information 121 over time. Mobile entity detector 113 generates mobile entity information 124 indicating the position and movement track of the mobile entity. Mobile entity information 124 is stored in information container 103. Details of mobile entity detector 113 will be described later.

Monitoring information generator 114 generates monitoring information 125 based on mobile entity information 124 and occlusion information 123. Monitoring information 125 is stored in information container 103. Monitoring information 125 is, for example, information for displaying, in a superimposed manner, the position and movement track of the mobile entity indicated by mobile entity information 124 and occlusion region 200 indicated by occlusion information 123 on the map including the radiation range. Details of monitoring information generator 114 will be described later.

Display processor 115 displays the contents of monitoring information 125 on a screen of a display apparatus (not illustrated). Examples of the display apparatus include a liquid crystal display, and, a PC, a tablet terminal, an in-vehicle device, and the like integrated with the liquid crystal display.

<Details of Scanning Information Generator>

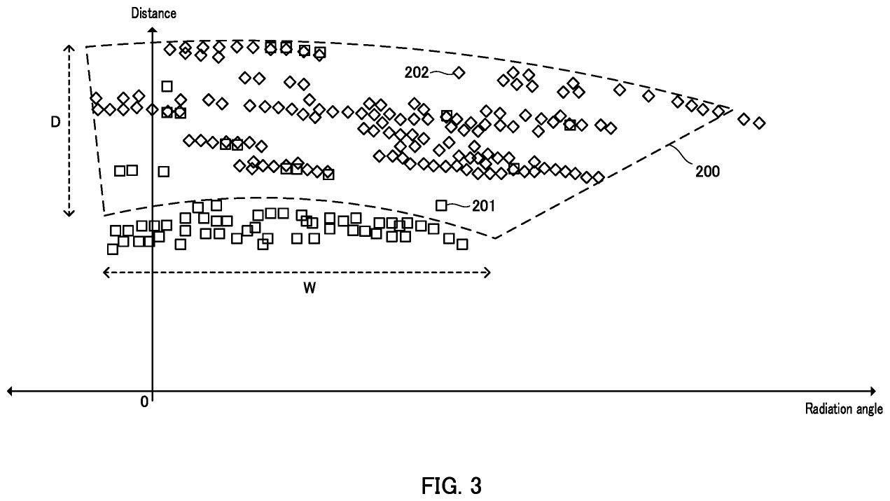

Details of scanning information generator 111 will be described with reference to the graph of FIG. 3.

FIG. 3 is a graph showing an example in which scanning information 121 is superimposed on background scanning information 122. In the graph of FIG. 3, the horizontal axis represents radiation angle θ, and the vertical axis represents the distance from radar apparatus 10. In FIG. 3, reflection positions 201 indicated by squares belong to scanning information 121, and reflection positions 202 indicated by rhombuses belong to background scanning information 122. Hereinafter, the reflection positions belonging to scanning information 121 are referred to as current reflection positions 201, and the reflection positions belonging to background scanning information 122 are referred to as background reflection positions 202.

As illustrated in FIG. 3, background reflection positions 202 corresponding to the positions of fixed structures in the background (e.g., buildings, fences, and the like) are mapped to background scanning information 122. Scanning information generator 111 may include, in background scanning information 122, information indicating weather at a time when the scanning is performed (hereinafter referred to as “weather information”). This is because the intensities and reflection directions of the reflected waves vary depending on the weather. The weather information is, for example, information indicating “fine weather,” “rain,” and “snow.”

Scanning information generator 111 may periodically update background scanning information 122. For example, scanning information generator 111 updates background scanning information 122 at seasonal changes. This is because background scanning information 122 changes depending on the weather as described above. In addition, the fixed structures in the background may also change over time.

Scanning information generator 111 may generate background scanning information 122 using a greater number of pieces of reflection position information than in the case of generation of scanning information 121. That is, the measurement time for radar apparatus 10 to generate background scanning information 122 may be longer than the measurement time for radar apparatus 10 to generate scanning information 121. It is thus possible to generate background scanning information 122 with higher accuracy.

Scanning information generator 111 may include, in scanning information 121 and background scanning information 122, identification information of radar apparatus 10 that has performed scanning. It is thus possible to identify which of the radiation ranges of radar apparatuses 10 scanning information 121 and background scanning information 122 relate to.

Note that, the present disclosure is described in relation to the case where scanning information 121 is a two-dimensional map as illustrated in FIG. 3, but scanning information 121 may be a three-dimensional map including a radiation range in the height direction.

<Details of Occlusion Estimator>

Details of occlusion estimator 112 will be described with reference to FIG. 3.

Based on the ratio of the number of current reflection positions 201 overlapping with background reflection positions 202 (hereinafter referred to as “overlap reflection positions”) to the number of background reflection positions 202 (hereinafter referred to as “overlap reflection position ratio”), occlusion estimator 112 estimates whether or not occlusion has occurred. For example, occlusion estimator 112 estimates that no occlusion has occurred when the overlap reflection position ratio is equal to or greater than a first threshold, and estimates that occlusion has occurred when the overlap reflection position ratio is less than the first threshold. In the case of FIG. 3, since the overlap reflection position ratio is extremely small although some of current reflection positions 201 overlap with background reflection positions 202, occlusion estimator 112 estimates that occlusion has occurred.

In estimation of the occurrence of the occlusion, occlusion estimator 112 may use background scanning information 122 corresponding to the weather at the timing when the scanning of scanning information 121 is performed. For example, when the weather at the timing when the scanning of scanning information 121 is performed is “rain,” occlusion estimator 112 uses background scanning information 122 corresponding to the weather information “rain.” It is thus possible to calculate the overlap reflection position ratio stably even in cases of different weather.

In cases of different weather, there is a typical tendency that the number of background reflection positions 202 varies between the cases of different weather, but the number of overlap reflection positions less varies. Thus, occlusion estimator 112 may change the first threshold for estimating the occurrence of occlusion depending on the weather at the timing when the scanning of scanning information 121 is performed. For example, occlusion estimator 112 may make the first threshold smaller in the case of the weather “rain” than in the case of the weather “fine weather.” For example, occlusion estimator 112 may make the first threshold smaller in the case of the weather “snow” than in the case of weather “rain.” It is thus possible for occlusion estimator 112 to stably estimate the occurrence of occlusion even in the cases of different weather. Further, when a change in the overlap reflection positions is assumed due to bad weather, the function of occlusion estimator 112 may be set by a user to be temporarily turned off.

When estimating that occlusion has occurred, occlusion estimator 112 estimates occlusion region 200. For example, occlusion estimator 112 clusters current reflection positions 201 adjacent to one another which do not overlap with background reflection positions 202 in scanning information 121, and calculates the width of occlusion region 200 based on length W of the cluster in the radiation angle direction. Further, in background scanning information 122, occlusion estimator 112 calculates the depth of occlusion region 200 based on length D in the distance direction in which background reflection positions 202 which do not overlap with current reflection positions 201 exist.

When estimating that occlusion has occurred, occlusion estimator 112 generates occlusion information 123 including the occurrence time, the time during which the occlusion having occurred continues (hereinafter referred to as “occlusion occurrence duration”), and information indicating the occlusion region, and stores the occlusion information in information container 103. The occlusion occurrence duration is used to calculate the reliability of the occlusion estimation. For example, the longer the occlusion occurrence duration, the higher the reliability of the occlusion estimation.

<Details of Mobile Entity Detector>

Details of mobile entity detector 113 will be described with reference to FIG. 3.

Mobile entity detector 113 clusters current reflection positions 201 which do not overlap with background reflection positions 202 in scanning information 121, and detects the position of a mobile entity based on the cluster. Further, mobile entity detector 113 detects the movement track of the mobile entity based on a change of the cluster over time.

Mobile entity detector 113 generates mobile entity information 124 based on the detected position and movement track of each mobile entity, and stores it in information container 103.

<Details of Monitoring Information Generator>

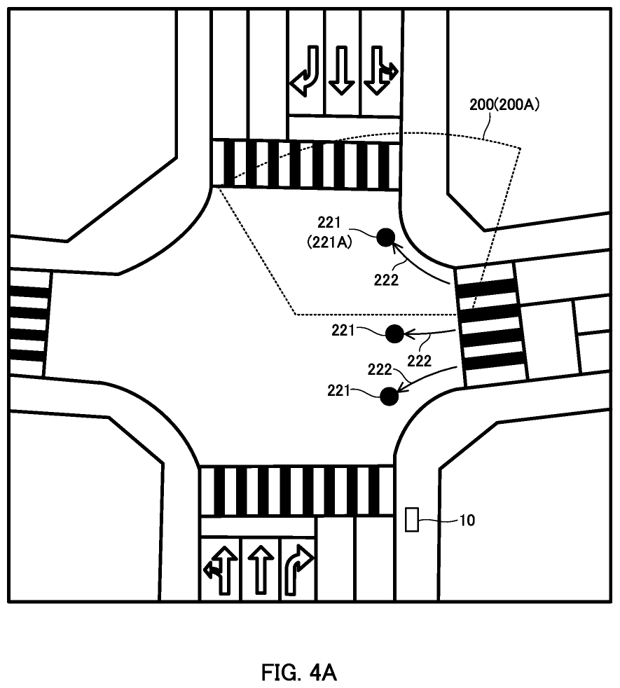

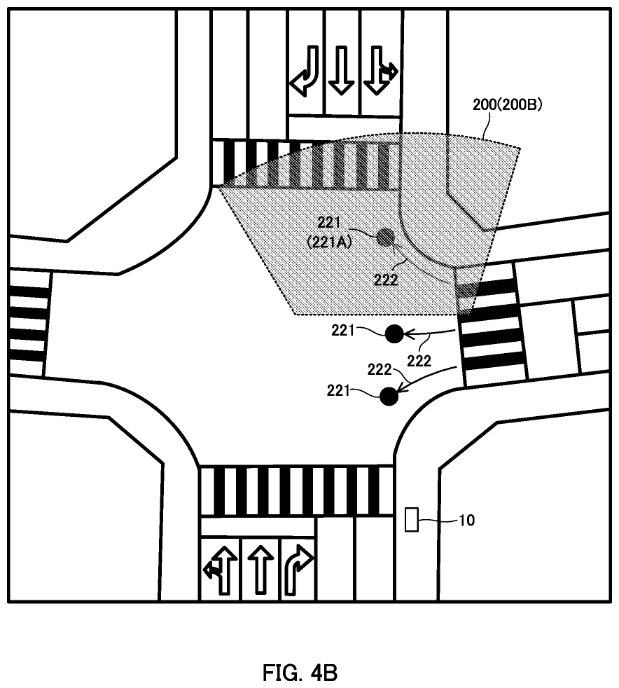

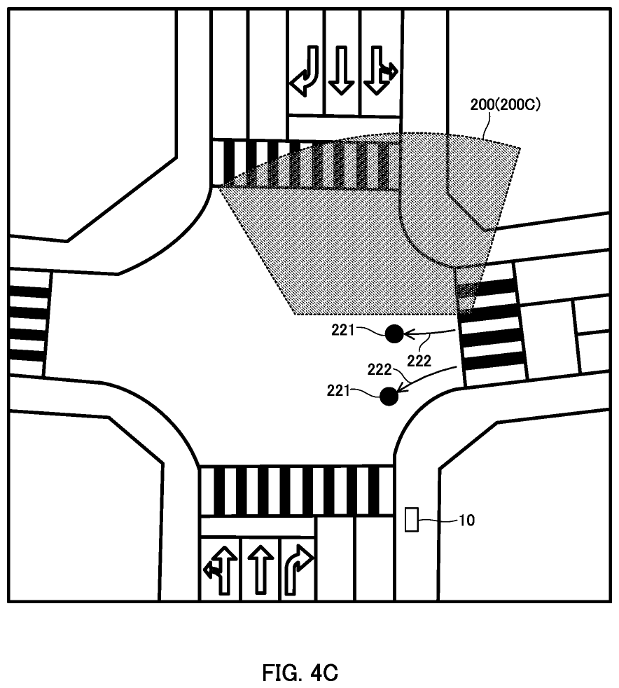

Referring to FIGS. 4A, 4B, and 4C, monitoring information generator 114 will be described in detail. FIGS. 4A, 4B, and 4C illustrate examples of display of the contents of monitoring information 125.

Monitoring information generator 114 maps positions 221 and movement tracks 222 of mobile entities indicated by mobile entity information 124 onto the map to generate monitoring information 125. It is thus possible for the user to recognize positions 221 and movement tracks 222 of the mobile entities at a glance from the display of the contents of monitoring information 125. Further, monitoring information generator 114 updates monitoring information 125 following the update of mobile entity information 124. Accordingly, the movements of the mobile entities over time are displayed as an animation.

When occlusion estimator 112 estimates that occlusion has occurred, monitoring information generator 114 maps occlusion region 200 indicated by occlusion information 123 onto the map to generate monitoring information 125. It is thus possible for the user to recognize whether or not occlusion has occurred and occlusion region 200 at a glance from the display of monitoring information 125. Further, monitoring information generator 114 updates monitoring information 125 following the update of occlusion information 123. It is thus possible for the user to recognize the change in occlusion region 200 at a glance.

Incidentally, mobile entity detector 113 may erroneously detect a mobile entity that does not exist actually (hereinafter referred to as a “false mobile entity”). For example, when there is vehicle C2 on the radar-apparatus side of tall heavy-duty truck C1 as illustrated in FIG. 1, radar apparatus 10 may receive a reflected wave repeatedly reflected between heavy-duty truck C1 and vehicle C2 on the radar-apparatus side. In this case, radar apparatus 10 may erroneously detect a false reflection position from this reflected wave as if vehicle C2 on the radar-apparatus side were present behind heavy-duty truck C1.

Since occlusion region 200 is unreachable by radar waves, the mobile entity detected within such occlusion region 200 is highly likely to be a false mobile entity (mobile entity 221A in FIGS. 4A and 4B). However, since, as described above, occlusion region 200 is also a result of estimation, it is probable that the estimation of occlusion region 200 is erroneous and the mobile entity detected within occlusion region 200 is not a false mobile entity.

Thus, monitoring information generator 114 displays the reliability of the occlusion estimation, and generates monitoring information 125 in which the display mode of the mobile entity detected within occlusion region 200 is changed according to the reliability. Note that, monitoring information generator 114 may calculate the reliability of the occlusion estimation based on the occlusion occurrence duration included in occlusion information 123, or may treat the value itself of the occlusion occurrence duration as the reliability. Hereinafter, specific examples will be described with reference to FIGS. 4A to 4C.

When the reliability of the occlusion estimation is less than a second threshold, monitoring information generator 114 generates monitoring information 125 showing occlusion region 200A in the first mode as illustrated in FIG. 4A.

When the reliability of the occlusion estimation is greater than or equal to the second threshold and less than a third threshold (where the second threshold<the third threshold), monitoring information generator 114 generates monitoring information 125 showing occlusion region 200B in the second mode as illustrated in FIG. 4B.

When the reliability of the occlusion estimation is equal to or greater than the third threshold, monitoring information generator 114 generates monitoring information 125 showing occlusion region 200C in the third mode as illustrated in FIG. 4C. Further, when the reliability of the occlusion estimation is equal to or greater than the third threshold, monitoring information generator 114 may hide the mobile entity existing within occlusion region 200C and delete the mobile entity from monitoring information 125. This is because it is highly likely that mobile entity 221A existing within sufficiently reliable occlusion region 200C is a false mobile entity that is erroneously detected by mobile entity detector 113.

According to this configuration, the display modes of occlusion region 200 allow the user to appropriately estimate the possibility of a decrease in the reliability of monitoring. In addition, it is possible to prevent a downstream system utilizing monitoring information 125 from malfunctioning due to detection of a false mobile entity.

<Processing Flow>

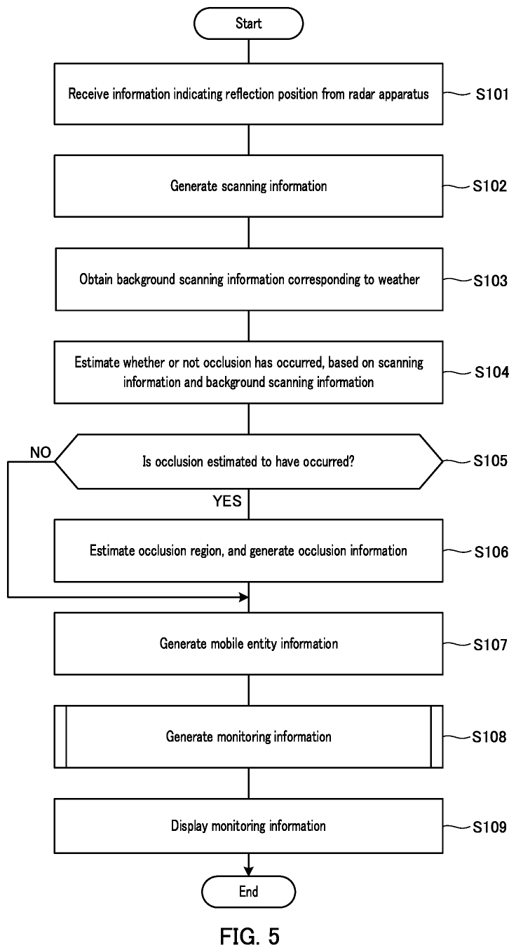

Next, the processing of monitoring apparatus 100 will be described with reference to the flowchart illustrated in FIG. 5. Note that, monitoring apparatus 100 repeatedly executes following steps S101 to S109.

Receiver 101 receives, from radar apparatus 10, information indicating reflection positions (S101).

Scanning information generator 111 generates scanning information 121 from the information indicating a plurality of reflection positions received at step S101 and stores it in information container 103 (S102). Occlusion estimator 112 obtains, from information container 103, background scanning information 122 corresponding to weather (S103).

Based on scanning information 121 generated at step S102 and background scanning information 122 obtained at S103, occlusion estimator 112 estimates whether or not occlusion has occurred (S104). When it is estimated that no occlusion has occurred (S105: NO), step S107 is performed.

When it is estimated that occlusion has occurred (S105: YES), step S106 is performed. That is, occlusion estimator 112 estimates occlusion region 200 based on scanning information 121 generated at step S102 and background scanning information 122 obtained at S103, and generates occlusion information 123 (S106). Then, step S107 is executed.

Mobile entity detector 113 detects positions 221 of mobile entities based on scanning information 121 generated at step S102 and background scanning information 122 obtained at S103. Further, based on the previous positions and the current positions of the mobile entities as detected, mobile entity detector 113 calculates movement tracks 222 of the mobile entities. Mobile entity detector 113 generates mobile entity information 124 indicating detected positions 221 and movement tracks 222 of the mobile entities, and stores it in information container 103 (S107).

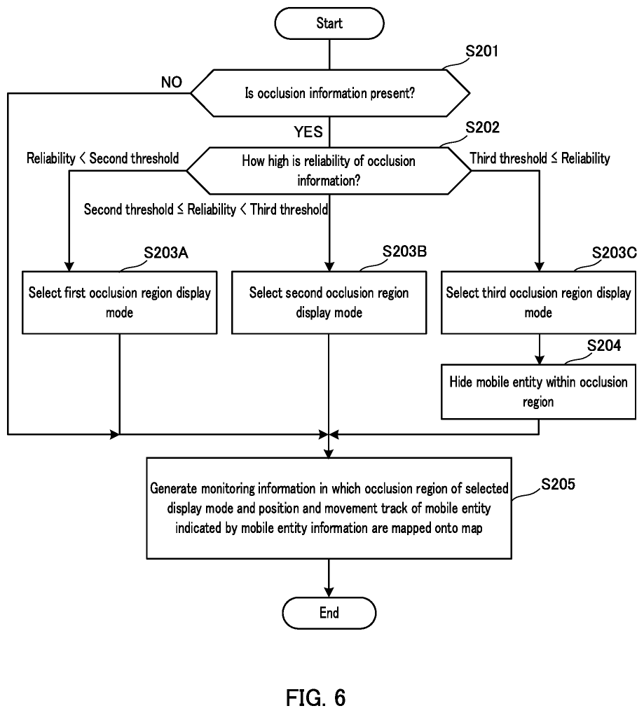

Monitoring information generator 114 generates monitoring information 125 based on occlusion information 123 (when step S106 is executed) and mobile entity information 124 generated at step S107 (S108). Note that step S108 will be described in detail later (see FIG. 6). Display processor 115 displays the contents of monitoring information 125 generated at step S108 on the display apparatus (S109).

Next, step S108 in FIG. 5 will be described in detail with reference to the flowchart illustrated in FIG. 6.

Monitoring information generator 114 judges whether or not occlusion information 123 has been generated at S106 in FIG. 6 (S201). When occlusion information 123 has not been generated (S201: NO), step S205 is executed.

When occlusion information 123 has been generated (S201: YES), monitoring information generator 114 executes one of the following steps depending on the reliability of occlusion information 123 (S202).

When the reliability of occlusion information 123 is less than the second threshold (S202: Reliability<Second threshold), monitoring information generator 114 selects the first occlusion region display mode illustrated in FIG. 4A (5203A). Then, step S205 is executed.

When the reliability of occlusion information 123 is greater than or equal to the second threshold and less than the third threshold (S202: Second threshold≤Reliability<Third threshold), monitoring information generator 114 selects the second occlusion region display mode illustrated in FIG. 4B (5203B). Then, step S205 is executed.

When the reliability of occlusion information 123 is equal to or greater than the third threshold (S202: Third threshold≤Reliability), monitoring information generator 114 selects the third occlusion region display mode illustrated in FIG. 4C (S203C). Then, monitoring information generator 114 hides and/or deletes a mobile entity within the occlusion region (S204). Then, step S205 is executed.

Monitoring information generator 114 generates monitoring information 125 in which the occlusion region of the display mode selected above and the positions and movement tracks of mobile entities indicated by mobile entity information 124 are mapped onto a map, and stores the monitoring information in information container 103 (S205).

By repeating the processes illustrated in FIGS. 5 and 6, monitoring apparatus 100 is capable of displaying images indicative of the movements of the mobile entities and the occlusion region on the map as illustrated in FIGS. 4A, 4B, and 4C. As is understood, when the reliability of the occlusion region is presented and the reliability of the occlusion region is sufficiently high, it is possible to hide and/or delete a mobile entity within the occlusion region to reduce erroneous recognition of a false mobile entity.

### Summary of Embodiment 1

Monitoring apparatus 100 according to Embodiment 1 includes: receiver 101 that receives the information indicating reflection positions of a radio wave in the millimeter-wave band radiated by radar apparatus 10; and controller 102 that estimates the positions of mobile entities in a radiation range of the radio wave and occurrence of the occlusion region in the radiation range, and displays the positions of the mobile entities and the occlusion region in the radiation range on a screen in a superimposed manner, the estimation being based on the reflection positions in a case where a mobile entity exists in the radiation range and the reflection positions in a case where no mobile entity exists in the radiation range, the occlusion region being unreachable by the radio wave. With this configuration, the occlusion region is superimposed and displayed on the screen together with the positions of the mobile entities. It is thus possible for the user to recognize that a result of detection within the occlusion region is unreliable.

Controller 102 may display, on the screen, the occlusion region in different modes depending on the reliability in estimation of the occurrence of the occlusion region. The reliability may be a value determined according to the duration of the occlusion region estimated to have occurred. Further, when the reliability is equal to or greater than a predetermined threshold, controller 102 does not need to display, on the screen, a mobile entity situated within the occlusion region. With this configuration, it is possible to prevent a false mobile entity from being displayed within the occlusion region, and thus prevent the user from being misled into recognizing the existence of the mobile entity.

Controller 102 may generate scanning information 121 by mapping a plurality of reflection positions in the case where a mobile entity exists in the radiation range, generate background scanning information 122 by mapping a plurality of reflection positions in the case where no mobile entity exists in the radiation range, and estimate the positions of mobile entities and the occurrence of the occlusion region in the radiation range based on scanning information 121 and background scanning information 122.

Controller 102 may associate the weather at the time when the radio wave is radiated for generating of background scanning information 122 with background scanning information 122. Then, controller 102 may estimate the occurrence of the occlusion region based on scanning information 121 and background scanning information 122 with which weather at the time when the radio wave is radiated for generating of scanning information 121 is associated. With this configuration, it is possible to suppress a decrease in the estimation accuracy of estimating the occlusion region that would be caused due to a weather change.

Controller 102 may estimate the occurrence of the occlusion region according to the ratio of the number of reflection positions overlapping between both scanning information 121 and background scanning information 122 to the number of reflection positions in background scanning information 122. With this configuration, the occurrence of the occlusion region can be estimated.

### Embodiment 2

Embodiment 2 will be described in relation to traffic flow measurement system 2 for measuring the traffic flow of a vehicle that is an example of the mobile entity. Note that, the same components are provided with the same reference numerals between Embodiment 2 and Embodiment 1, and a description thereof may be omitted.

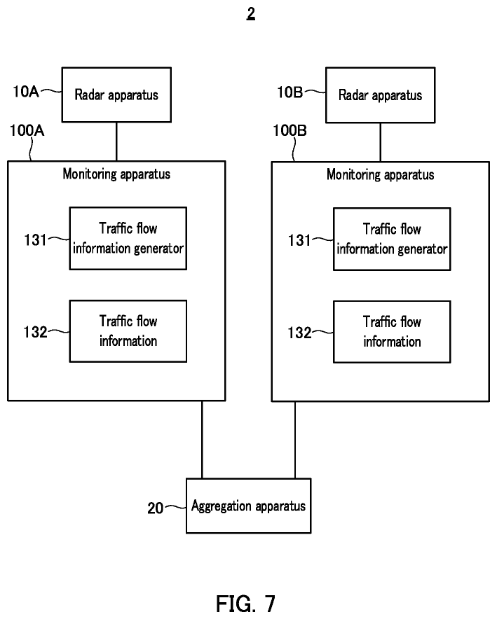

FIG. 7 illustrates a configuration example of traffic flow measurement system 2 according to Embodiment 2. Traffic flow measurement system 2 includes radar apparatuses 10A and 10B, monitoring apparatuses 100A and 100B, and aggregation apparatus 20. Monitoring apparatuses 100A and 100B are connected to aggregation apparatus 20 via a predetermined network.

Each of monitoring apparatuses 100 includes traffic flow information generator 131 in place of monitoring information generator 114 described with respect to Embodiment 1, and traffic flow information 132 in place of monitoring information 125.

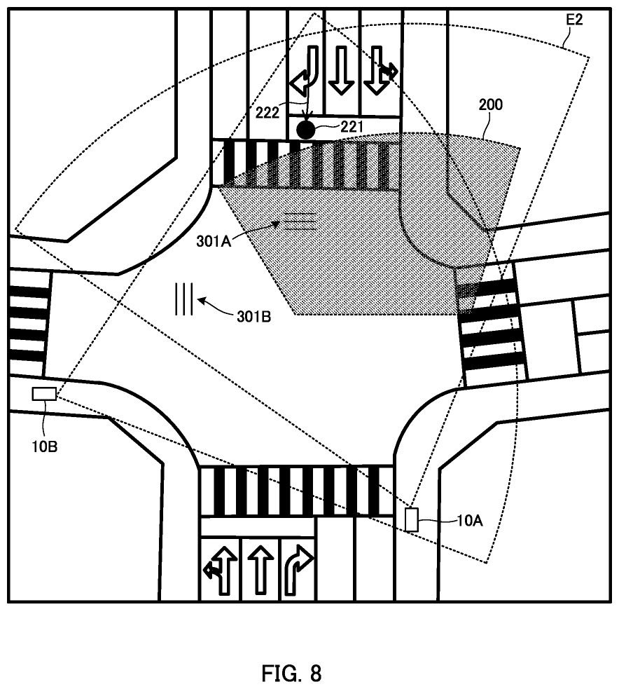

As illustrated in FIG. 8, traffic flow information generator 131 sets count lines 301A at a passing position at which vehicle 221 passes in radiation range E2 of radar apparatus 10A. Then, traffic flow information generator 131 counts the number of times movement track 222 of vehicle 221 has passed count lines 301A, and generates traffic flow information 132. Monitoring apparatuses 100 transmit generated traffic flow information 132 to aggregation apparatus 20.

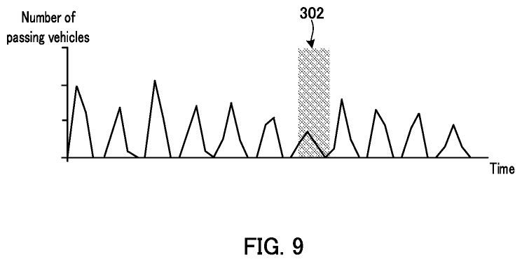

Aggregation apparatus 20 integrates traffic flow information 132 received from monitoring apparatuses 100A and 100B to calculate the integrated traffic flow of the vehicle in a predetermined area (hereinafter referred to as “integrated traffic flow”). Further, as illustrated in FIG. 9, aggregation apparatus 20 displays a graph indicating the number of vehicles that have passed count lines 301A for each time as an example of display of information indicating the integrated traffic flow.

Traffic flow measurement system 2 performs at least one of the following (2-1) to (2-3).

(2-1) When occlusion region 200 including at least a part of count lines 301A occurs, traffic flow information generator 131 moves count lines 301A to another position 301B outside occlusion region 200. For example, as illustrated in FIG. 8, when occlusion region 200 including count lines 301A for vehicles turning right occurs, count lines 301A for the vehicles turning right are moved to position 301B at which the vehicles turning right pass and which is not included in occlusion region 200. It is thus possible to count the number of vehicles turning right in the occlusion occurrence duration.

(2-2) Traffic flow information generator 131 includes the occlusion occurrence duration in traffic flow information 132. As illustrated in FIG. 9, aggregation apparatus 20 also displays, in the graph showing the integrated traffic flow, time section 302 corresponding to the occlusion occurrence duration included in traffic flow information 132. It is thus possible for the user looking at the graph to recognize that the number of passing vehicles in the occlusion occurrence duration is less reliable than the number of passing vehicles in an occlusion non-occurrence time.

(2-3) When the information indicating the occurrence of occlusion region 200 is received from one monitoring apparatus 100A, aggregation apparatus 20 transmits, to the other monitoring apparatus 100B, an instruction for covering occlusion region 200. When receiving the instruction for covering occlusion region 200, the other monitoring apparatus 100B performs processing for covering occlusion region 200. For example, the other monitoring apparatus 100B instructs radar apparatus 10B to include occlusion region 200 also in the radiation range. Alternatively, the other monitoring apparatus 100B receives, from radar apparatus 10B, information indicating more reflection positions (i.e., by prolonged scanning) to generate more accurate scanning information 121. It is thus possible for the other monitoring apparatus 100B to count the number of vehicles passing count lines 301A in occlusion region 200.

### Embodiment 3

Embodiment 3 will be described in relation to opposite travel detection system 3 for detecting the opposite travel of a vehicle that is an example of the mobile entity. Note that, the same components are provided with the same reference numerals between Embodiment 3 and Embodiment 1, and a description thereof may be omitted.

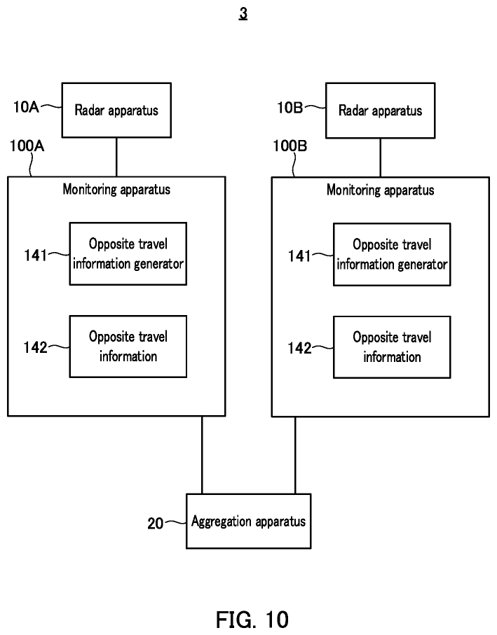

FIG. 10 illustrates a configuration example of opposite travel detection system 3 according to Embodiment 3. Opposite travel detection system 3 includes radar apparatuses 10A and 10B, monitoring apparatuses 100A and 100B, and aggregation apparatus 20. Monitoring apparatuses 100A and 100B are connected to aggregation apparatus 20 via a predetermined network.

Each of monitoring apparatuses 100 includes opposite travel information generator 141 in place of monitoring information generator 114 described with respect to Embodiment 1, and opposite travel information 142 in place of monitoring information 125.

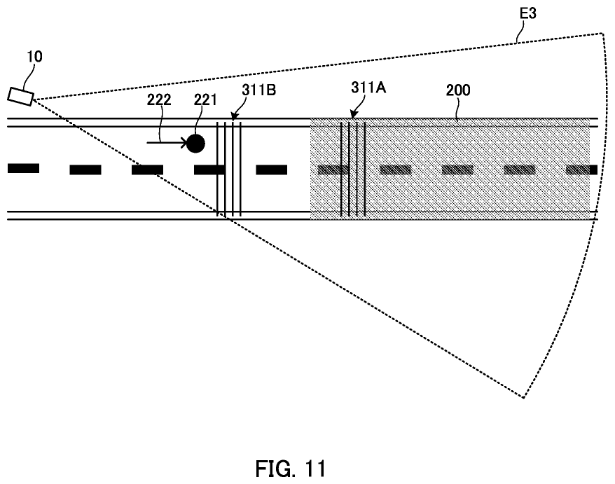

As illustrated in FIG. 11, opposite travel information generator 141 sets opposite travel judgement lines 311A at a passing position at which a vehicle traveling in an opposite direction (hereinafter, also referred to as “opposite travel vehicle”) passes in radiation range E3 of radar apparatus 10. When the movement track of a vehicle passes opposite travel judgement lines 311A, opposite travel information generator 141 detects the vehicle as the opposite travel vehicle and generates opposite travel information 142 including the detection result. Opposite travel information 142 is transmitted to aggregation apparatus 20.

Aggregation apparatus 20 displays the detection result of detection of the opposite travel vehicle on each road based on opposite travel information 142 received from monitoring apparatuses 100.

Opposite travel detection system 3 performs at least one of the following (3-1) and (3-2).

(3-1) When occlusion region 200 including at least a part of opposite travel judgement lines 311A occurs, opposite travel information generator 141 moves opposite travel judgement lines 311A to different position 311B outside occlusion region 200 as illustrated in FIG. 11. For example, as illustrated in FIG. 11, original opposite travel judgement lines 311A are moved to forward or backward position 311B on the road. It is thus possible to avoid indetectability of the opposite travel vehicle in the occlusion occurrence duration.

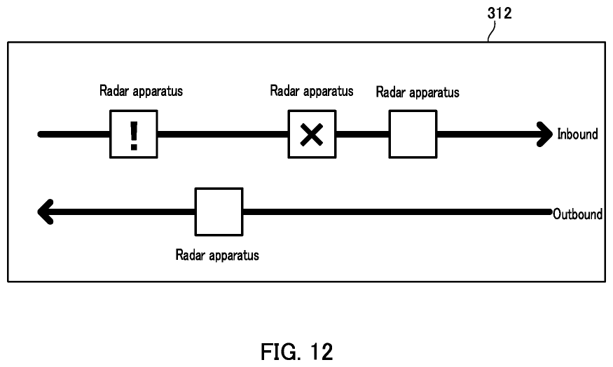

(3-2) Opposite travel information generator 141 includes the occlusion occurrence duration in opposite travel information 142. When receiving opposite travel information 142 including the occlusion occurrence duration, aggregation apparatus 20 displays, in opposite travel monitoring image 312, a mark (the mark of “!” in FIG. 12”) indicative of the indetectability of the opposite travel vehicle in the radiation range of one of radar apparatuses 10 corresponding to such opposite travel information 142 as illustrated in FIG. 12. It is thus possible for the user to recognize, from opposite travel monitoring image 312, in which radiation range the opposite travel vehicle is indetectable. Note that, when the opposite travel vehicle is detected in the radiation range of radar apparatus 10 corresponding to opposite travel information 142, aggregation apparatus 20 may display, in opposite travel monitoring image 312, a mark (the mark of “×” in FIG. 12) indicating that the opposite travel vehicle is detected.

### Embodiment 4

Embodiment 4 will be described in relation to pedestrian detection system 4 for detecting a pedestrian that is an example of the mobile entity. Note that, the same components are provided with the same reference numerals between Embodiment 4 and Embodiment 1, and a description thereof may be omitted.

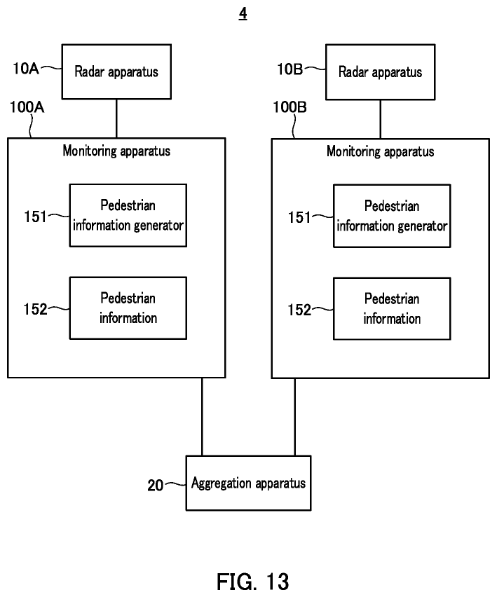

FIG. 13 illustrates a configuration example of pedestrian detection system 4 according to Embodiment 4. Pedestrian detection system 4 includes radar apparatuses 10A and 10B, monitoring apparatuses 100A and 100B, and aggregation apparatus 20. Monitoring apparatuses 100A and 100B are connected to aggregation apparatus 20 via a predetermined network.

Each of monitoring apparatuses 100 includes pedestrian information generator 151 in place of monitoring information generator 114 described with respect to Embodiment 1, and pedestrian information 152 in place of monitoring information 125.

From scanning information 121 including the crosswalk in radiation range E1 (see FIG. 1), pedestrian information generator 151 detects a pedestrian who is crossing a crosswalk, and generates pedestrian information 152 including the detection result. Pedestrian information 152 is transmitted to aggregation apparatus 20.

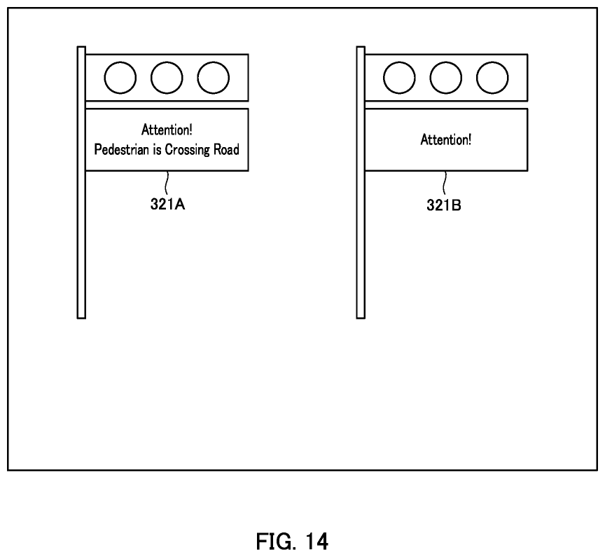

Based on pedestrian information 152 received from monitoring apparatuses 100, aggregation apparatus 20 displays, to the vehicle, information for calling attention to the pedestrian who is crossing the crosswalk (hereinafter referred to as “attention calling information”). As illustrated in FIG. 14, the attention calling information may be displayed on an electric bulletin board installed on traffic lights. Alternatively, the attention calling information may be displayed on a monitor in a vehicle located near the crosswalk.

Pedestrian detection system 4 performs at least one of the following (4-1) and (4-2).

(4-1) When occlusion region 200 including at least a part of the crosswalk occurs, pedestrian information generator 151 includes information indicating the occurrence of the occlusion in pedestrian information 152. When pedestrian information 152 includes the information indicating the occurrence of the occlusion, aggregation apparatus 20 displays attention calling information in a mode different from that in the case where no occlusion occurs. For example, as illustrated in FIG. 14, aggregation apparatus 20 displays attention calling information 321A of “Attention! Pedestrian is Crossing Road” when no occlusion occurs, and simply displays attention calling information 321B of “Attention!” when the occlusion occurs. This is because, in the case of occurrence of occlusion, detection of a pedestrian in occlusion region 200 becomes impossible, and it cannot be determined whether or not there is any pedestrian on the crosswalk. Thus, in the case of occurrence of occlusion, it is possible to prevent the attention calling information indicative of presence of a pedestrian crossing the crosswalk from being erroneously displayed in spite of absence of any pedestrian on the crosswalk.

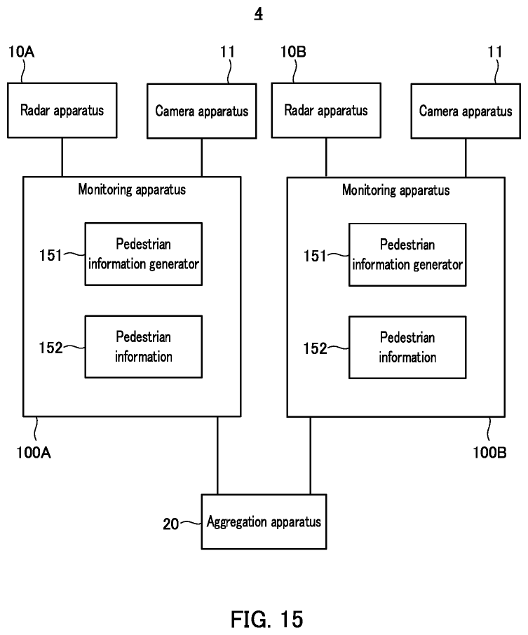

(4-2) When receiving pedestrian information 152 including the information indicating the occurrence of occlusion from one monitoring apparatus 100A, aggregation apparatus 20 transmits, to the other monitoring apparatus 100B, an instruction for covering the occlusion region. Alternatively, as illustrated in FIG. 15, when camera apparatus 11 that is an example of an apparatus different from radar apparatus 10 is connected to monitoring apparatus 100, aggregation apparatus 20 may perform the following processing. That is, aggregation apparatus 20 transmits, to the other monitoring apparatus 100B, an instruction for detecting a pedestrian on a crosswalk using camera apparatus 11. Monitoring apparatus 100B having received this instruction detects the pedestrian on the crosswalk using camera apparatus 11, and generates pedestrian information 152 based on the detection result. With this configuration, it is possible to prevent indetectability of the pedestrian on the crosswalk in the occlusion occurrence duration.

### Embodiment 5

Embodiment 5 will be described in relation to intruder detection system 5 for detecting an intruder being an example of the mobile entity who intrudes into an intruder detection area. Note that, the same components are provided with the same reference numerals between Embodiment 5 and Embodiment 1, and a description thereof may be omitted.

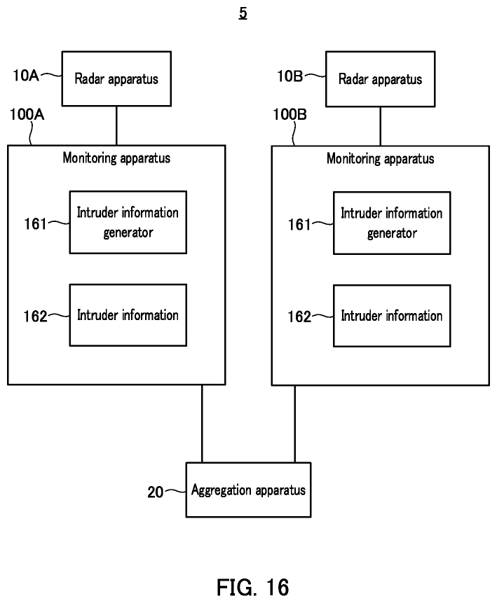

FIG. 16 illustrates a configuration example of intruder detection system 5. Intruder detection system 5 includes radar apparatuses 10A and 10B, monitoring apparatuses 100A and 100B, and aggregation apparatus 20. Monitoring apparatuses 100A and 100B are connected to aggregation apparatus 20 via a predetermined network.

Each of monitoring apparatuses 100 includes intruder information generator 161 in place of monitoring information generator 114 described with respect to Embodiment 1, and intruder information 162 in place of monitoring information 125.

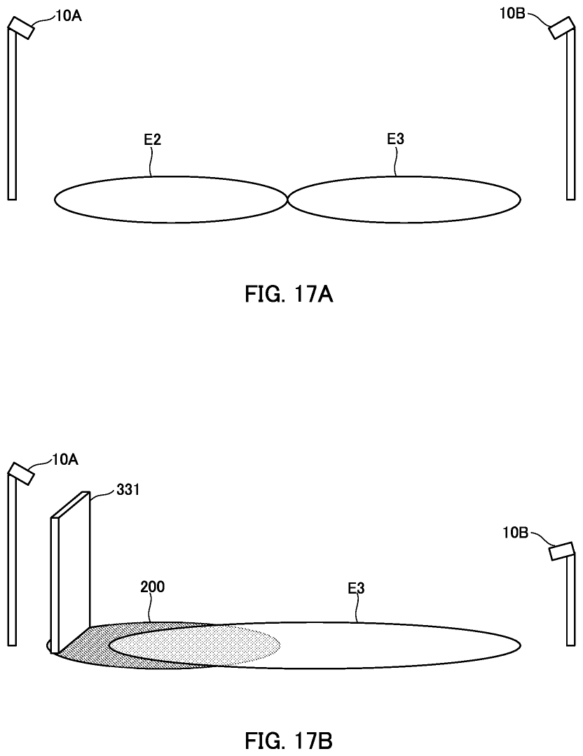

As illustrated in FIG. 17A, intruder information generator 161 detects an intruder into radiation range E2 from scanning information 121 for radiation range E2, and generates intruder information 162 including the detection result. Intruder information 162 is transmitted to aggregation apparatus 20. The same applies to radiation range E3.

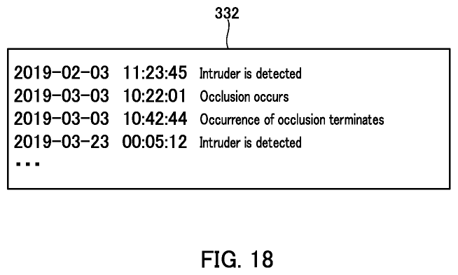

Based on intruder information 162 received from monitoring apparatuses 100, aggregation apparatus 20 generates and displays monitoring log information 332 (see FIG. 18) indicating a monitoring result of monitoring radiation ranges E2 and E3.

Intruder detection system 5 performs at least one of the following (5-1) and (5-2).

(5-1) Intruder information generator 161 includes, in intruder information 162, information indicating the start time and the end time of the occlusion occurrence duration. When the information indicating the start time and the end time of the occlusion occurrence duration is included in intruder information 162, aggregation apparatus 20 also includes this information in monitoring log information 332 as illustrated in FIG. 18. It is thus possible for the user to recognize from monitoring log information 332 that the reliability of intruder detection between the start time and the end time of the occlusion occurrence duration is low.

(5-2) When receiving, from one monitoring apparatus 100A, intruder information 162 including information indicating occurrence of occlusion region 200, aggregation apparatus 20 transmits, to the other monitoring apparatus 100B, an instruction for covering occlusion region 200. When receiving this instruction for covering occlusion region 200, the other monitoring apparatus 100B performs processing for covering occlusion region 200. For example, as illustrated in FIG. 17B, when occlusion region 200 occurs due to obstacle 331 in radiation range E2 of radar apparatus 10A, aggregation apparatus 20 transmits, to monitoring apparatus 100B, the instruction for covering occlusion region 200. Monitoring apparatus 100B having received this instruction changes radiation range E3 of radar apparatus 10B to cover at least a portion of occlusion region 200, for example, by lowering the height of radar apparatus 10B and changing the radiation angle of the radar wave as illustrated in FIG. 17B. It is thus possible to cover at least a part of occlusion region 200.

### Summary of Embodiments 2 to 5

Each of the monitoring systems (2, 3, 4, and 5) according to the embodiments includes: radar apparatus 10 that generates the information indicating reflection positions of a radiated radio wave in a millimeter wave band; and monitoring apparatus 100 that performs, based on the information indicating the reflection positions, detection of mobile entities in a radiation range of the radio wave and judgement of whether or not an occlusion region being unreachable by the radio wave has occurred in the radiation range, and generates the monitoring information (132, 142, 152, or 162) including the information indicating a result of detection of the mobile entities and the information indicating whether or not an occlusion region has occurred. With this configuration, the reliability of the detection result included in the monitoring information can be determined based on the information included in the monitoring information and indicating whether or not the occlusion region has occurred.

The monitoring system may include aggregation apparatus 20 that receives and manages the monitoring information from at least one monitoring apparatus 100.

When lines disposed in the radiation range and used for detecting passage of a mobile entity is at least partly included in the occlusion region, monitoring apparatus 100 may move the lines to a position not included in the occlusion region. With this configuration, it is possible to detect a mobile entity passing the lines even in the occlusion occurrence duration.

Monitoring apparatus 100 may dispose the count lines in a travel lane. Monitoring apparatus 100 may include, in the monitoring information, the number of mobile entities (vehicles) that have passed the count lines, and transmit the monitoring information to aggregation apparatus 20. Aggregation apparatus 20 may display, on the screen, a transition of the number of mobile entities over time included in the monitoring information and a time period in which the occlusion region occurred and continued. This configuration allows the user to recognize that the number of mobile entities in the time period in which the occlusion region occurred and continued is unreliable.

Monitoring apparatus 100 may dispose the opposite travel judgement lines in the travel lane. Monitoring apparatus 100 may include, in the monitoring information, information indicating whether or not a mobile entity (vehicle) traveling in an opposite direction to pass the opposite travel judgement lines has been detected, and transmit the monitoring information to aggregation apparatus 20. Aggregation apparatus 20 may display, on the screen, information indicating occurrence of opposite travel when the monitoring information includes information indicating detection of a mobile entity traveling in the opposite direction, and may display, on the screen, information indicating indetectability of opposite travel when the monitoring information includes information indicating occurrence of an occlusion region. This configuration allows the user to recognize an area in which opposite travel is indetectable due to the occurrence of the occlusion region.

Monitoring apparatus 100 may include, in the monitoring information, information indicating whether or not a mobile entity (pedestrian) exists in the radiation range (crosswalk), and may transmit the monitoring information to aggregation apparatus 20. Aggregation apparatus 20 may display, on the screen, information for calling attention when the monitoring information includes information indicating the presence of the mobile entity. Here, the information for calling attention may be displayed in different modes between the case where the monitoring information includes the information indicating the occurrence of the occlusion region and the case where the monitoring information does not include such information. With this configuration, it is possible to display the information for calling an appropriate attention taking into consideration the reliability according to the occurrence or absence of the occlusion region.

Monitoring apparatus 100 may include, in the monitoring information, information indicating whether or not a mobile entity (intruder) is detected in the radiation range (intruder detection area) and transmit the monitoring information to aggregation apparatus 20. Aggregation apparatus 20 may generate, from the monitoring information, monitoring log information 332 including the time at which the mobile entity was detected and the time period in which the occlusion region occurred and continued (the start time and the end time of occlusion occurrence). This configuration allows the user or another apparatus to recognize, from monitoring log information 332, a time period in which the reliability of intruder detection is low.

Although the embodiments according to the present disclosure have been described above in detail with reference to the drawings, the functions of monitoring apparatus 100 and aggregation apparatus 20 described above can be implemented by a computer program.

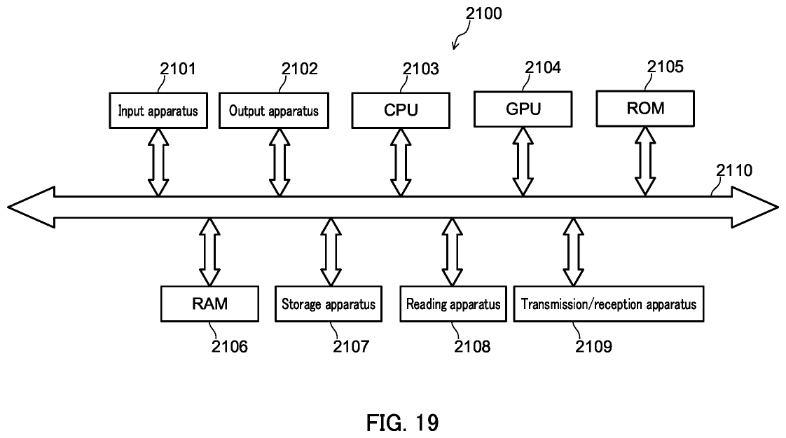

FIG. 19 illustrates a hardware configuration of a computer in which the functions of the apparatuses are implemented by a program. This computer 2100 includes input apparatus 2101 such as a keyboard, mouse, touch pen, and/or touch pad, output apparatus 2102 such as a display or speaker, Central Processing Unit (CPU) 2103, Graphics Processing Unit (GPU) 2104, Read Only Memory (ROM) 2105, Random Access Memory (RAM) 2106, storage apparatus 2107 such as a hard disk apparatus or a Solid State Drive (SSD), reading apparatus 2108 for reading information from recording medium such as a Digital Versatile Disk Read Only Memory (DVD-ROM) or a Universal Serial Bus (USB) memory, and transmission/reception apparatus 2109 for communicating over a network, which are connected to one another by bus 2110.

Reading apparatus 2108 reads a program for implementing the functions of the respective apparatuses from the recording medium in which the program is recorded, and stores the program in storage apparatus 2107. Alternatively, transmission/reception apparatus 2109 communicates with a server apparatus connected to the network to download, from the server apparatus, the aforementioned program for implementing the functions of the respective apparatuses and store the program in storage apparatus 2107.

Then, CPU 2103 copies the program stored in storage apparatus 2107 to RAM 2106, and sequentially reads instructions included in the program from RAM 2106, so as to implement the functions of the respective apparatuses.

For example, in monitoring apparatus 100 illustrated in FIG. 2, receiver 101 is realized by transmission/reception apparatus 2109, controller 102 is realized by CPU 2103, and information container 103 is realized by RAM 2106 and storage apparatus 2017.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

The disclosure of Japanese Patent Application No. 2019-115728 dated Jun. 21, 2019 including the specification, drawings and abstract is incorporated herein by reference in its entirety.

### INDUSTRIAL APPLICABILITY

One aspect of the present disclosure is useful for object detection by radar.

### REFERENCE SIGNS LIST

1 Monitoring system
2 Traffic flow measurement system
3 Opposite travel detection system
4 Pedestrian detection system
5 Intruder detection system
10, 10A, 10B Radar apparatus
20 Aggregation apparatus
100, 100A, 100B Monitoring apparatus
101 Receiver
102 Controller
103 Information container
111 Scanning information generator
112 Occlusion estimator
113 Mobile entity detector
114 Monitoring information generator
115 Display processor
121 Scanning information
122 Background scanning information
123 Occlusion information
124 Mobile entity information
125 Monitoring information
131 Traffic flow information generator
132 Traffic flow information
141 Opposite travel information generator
142 Opposite travel information
151 Pedestrian information generator
152 Pedestrian information
161 Intruder information generator
162 Intruder information

1. A monitoring system, comprising:
a radar apparatus that generates information indicating a reflection position of a radio wave radiated; and
a monitoring apparatus that performs, based on the information indicating the reflection position, detection of one or more mobile entities in a radiation range of the radio wave and judgement of whether or not an occlusion region being unreachable by the radio wave has occurred in the radiation range, and generates monitoring information including information indicating a result of the detection of the one or more mobile entities and information indicating whether or not the occlusion region has occurred.

2. The monitoring system according to claim 1, wherein,
when a line disposed in the radiation range and used for detecting passage of the one or more mobile entities is at least partly included in the occlusion region, the monitoring apparatus moves the line to a position not included in the occlusion region.

3. The monitoring system according to claim 2, further comprising:
an aggregation apparatus that receives the monitoring information from the monitoring apparatus, wherein
the monitoring apparatus
disposes the line in a travel lane, and
includes, in the monitoring information, a number of the one or more mobile entities having passed the line, and
the aggregation apparatus displays, on a screen, a transition of the number of the one or more mobile entities included in the monitoring information and a time period in which the occlusion region occurred and continued.

4. The monitoring system according to claim 2, further comprising:
an aggregation apparatus that receives the monitoring information from the monitoring apparatus, wherein
the monitoring apparatus
disposes the line in a travel lane, and
includes, in the monitoring information, information indicating whether or not the one or more mobile entities traveling in an opposite direction to pass the line have been detected, and,
the aggregation apparatus
displays information indicative of occurrence of opposite travel on the screen in a case where the monitoring information includes information indicating detection of the one or more mobile entities traveling in the opposite direction, and
displays information indicative of indetectability of the opposite travel on the screen in a case where the monitoring information includes information indicating occurrence of the occlusion region.

5. The monitoring system according to claim 1, further comprising:
an aggregation apparatus that receives the monitoring information from the monitoring apparatus, wherein
the monitoring apparatus includes, in the monitoring information, information indicating whether or not the one or more mobile entities are present in the radiation range, and
the aggregation apparatus displays information for calling attention on a screen when the monitoring information includes information indicating presence of the one or more mobile entities, and
the information for calling attention is displayed in a mode different between a case where the monitoring information includes information indicating occurrence of the occlusion region and a case where the monitoring information does not include the information indicating the occurrence of the occlusion region.

6. The monitoring system according to claim 1, further comprising:
an aggregation apparatus that receives the monitoring information from the monitoring apparatus, wherein
the monitoring apparatus includes, in the monitoring information, information indicating whether or not the one or more mobile entities have been detected in the radiation range, and
the aggregation apparatus generates, from the monitoring information, a monitoring log including time at which the one or more mobile entities were detected and a time period in which the occlusion region occurred and continued.

7. The monitoring system according to claim 1, wherein
The radio wave is a radio wave in a millimeter-wave band.

8. A monitoring method, comprising steps performed by a monitoring system of:
generating information indicating a reflection position of a radio wave radiated; and
performing, based on the information indicating the reflection position, detection of one or more mobile entities in a radiation range of the radio wave and judgement of whether or not an occlusion region being unreachable by the radio wave has occurred in the radiation range, and generating monitoring information including information indicating a result of the detection of the one or more mobile entities and information indicating whether or not the occlusion region has occurred.
